(19) United States
(12) Patent Application Publication
(10) Pub. No.: US 2021/0258485 A1
(43) Pub. Date: Aug. 19, 2021

(54) VIRTUAL REALITY REAL-TIME SHOOTING MONITORING SYSTEM AND CONTROL METHOD THEREOF

(71) Applicant: Pu-Yuan Cheng, Taipei City (TW)

(72) Inventors: PU-YUAN CHENG, TAIPEI CITY (TW); YI-CHENG CHEN, TAIPEI CITY (TW); MING-YUAN CHUAN, TAIPEI CITY (TW); CHE-YU CHOU, TAIPEI CITY (TW)

(21) Appl. No.: 17/239,340

(22) Filed: Apr. 23, 2021

Related U.S. Application Data
(63) Continuation of application No. PCT/CN2018/111813, filed on Oct. 25, 2018.

(51) Int. Cl. H04N 5/232; H04N 9/31; G06T 1/20

(52) U.S. Cl. CPC H04N 5/23238; G06T 1/20; H04N 9/3182

(57) ABSTRACT

The application discloses a virtual reality (VR) real-time filming and monitoring system, configured to allow a user to shoot a video and play a first VR screening video, and allow the user to input an image processing control signal and an editing command into the VR real-time filming and monitoring system in real-time, according to the first VR screening video. The VR real-time filming and monitoring system includes a camera module, a first image processing module, an output module, an editing module, and a real-time play module. The camera module is configured to shoot a video to generate an original video. The first image processing module processes the original video according to an image processing control signal to generate a real-time video temporary data. The output module generates a first VR screening video according to the real-time video temporary data. The editing module generates an edited data according to the real-time video temporary data and an editing command. The real-time play module is configured to play the first VR screening video.

### CROSS-REFERENCE TO RELATED APPLICATIONS

This application is a continuation of International Application No. PCT/CN2018/111813, filed on Oct. 25, 2018, the disclosure of which is hereby incorporated by reference in its entirety.

### TECHNICAL FIELD

The present application relates to a filming and monitoring system for virtual reality filmmaking and a method for controlling the same, particularly to a filming and monitoring system capable of monitoring and adjusting the virtual reality filmmaking and a method for controlling the same.

### BACKGROUND

Generally, when filming virtual reality (VR) videos, users employ multiple cameras to form a VR camera with a 360-degree filming angle to shoot VR videos. Virtual reality means that the user can see a 360-degree view without blind spots through a head-mounted VR device, such as a VR headset, to achieve an immersive experience.

To film VR videos (such as short films and feature films), the camera operator and the director need to review the VR content created in real-time, in order to control all the scenes and actors within the 360-degree scene. However, they cannot review the stitched image in real-time because of the current high-quality recording and complex computation. The cinema operator and the director can only view the unfolded image on a conventional play device, and they cannot view the film directly from the audiences' perspective with a VR play device, such as a VR headset.

Therefore, the director may find that some segments are not satisfactory and may need to be re-took only after the VR film is completed, which increases the overall shooting cost and a delay in the schedule.

### SUMMARY OF THE INVENTION

One purpose of the present disclosure is to disclose a VR real-time filming and monitoring system and a method for controlling the same, wherein the system and method can be used to monitor and adjust the VR video in real-time to solve the issues mentioned above.

One embodiment of the present application discloses a VR real-time filming and monitoring system, configured to allow a user to shoot a video and play a first VR screening video, and allow the user to input an image processing control signal and an editing command into the VR real-time filming and monitoring system in real-time, according to the first VR screening video. The VR real-time filming and monitoring system includes a camera module, a first image processing module, an output module, an editing module, and a real-time play module. The camera module is configured to shoot a video to generate an original video. The first image processing module processes the original video according to an image processing control signal to generate a real-time video temporary data. The output module generates the first VR screening video according to the real-time video temporary data. The editing module generates an edited data according to the real-time video temporary data and an editing command. The real-time play module is configured to play the first VR screening video.

Another embodiment of the present application discloses VR real-time filming and monitoring method. The VR real-time filming and monitoring method includes the following steps: shooting a video and generating an original video; processing the original video in real-time according to an image processing control signal to generate a real-time video temporary data; generating a first VR screening video according to the real-time video temporary data; adjusting the image processing control signal according to the first VR screening video.

Yet another embodiment of the present application discloses a method for controlling a VR real-time filming and monitoring system, wherein the VR real-time filming and monitoring system includes a camera module, a first image processing module, and an output module real-time play module, and the method is characterized in including the following steps: using the camera module to shoot a video and generate an original video; controlling the first image processing module to process the original video in real-time according to an image processing control signal to generate a real-time video temporary data; controlling the output module to generate a first VR screening video according to the real-time video temporary data; controlling the real-time play module to play the first VR screening video.

The VR real-time filming and monitoring system and method for controlling the same according to embodiments of the present application uses a first image processing module to process the original video in real-time, which allows the user to examine the screening video and adjust or edit the video in real-time, thereby reducing the filming cost and improving the filming efficiency.

### BRIEF DESCRIPTION OF THE DRAWINGS

FIG. 1 is a functional block diagram of a VR real-time filming and monitoring system according to one embodiment of the present application.

FIG. 2 is a functional block diagram of a first image processing module according to one embodiment of the present application.

FIG. 3 is a schematic diagram illustrating a VR real-time filming and monitoring system according to one embodiment of the present application.

FIG. 4 is a flow chart illustrating a VR real-time filming and monitoring method according to one embodiment of the present application.

FIG. 5 is a flowchart illustrating a method for controlling a VR real-time filming and monitoring system according to one embodiment of the present application.

### DETAILED DESCRIPTION

Certain terms are used to describe or designate specific elements or components in the specification and the annexed claims. Persons having ordinary skill in the art should understand that manufacturers may use different terms to refer to the same elements or components. The terminology of elements or components shall not be used to distinguish the elements or components; rather, the elements or components shall be distinguished depending on their differences in terms of functionality. Throughout the specification and the annexed claims, the terms “comprise,” “comprising,” “include,” and “including” are used in the inclusive, open sense and shall be interpreted as “including, but not limited to.” Additionally, the terms “couple” and “coupling” include all means for direct and indirect coupling or connection. Therefore, the description of a first device being coupled to a second device means that the first device is directly coupled to the second device or it is coupled to the second device indirectly through an intervening device or other connection means.

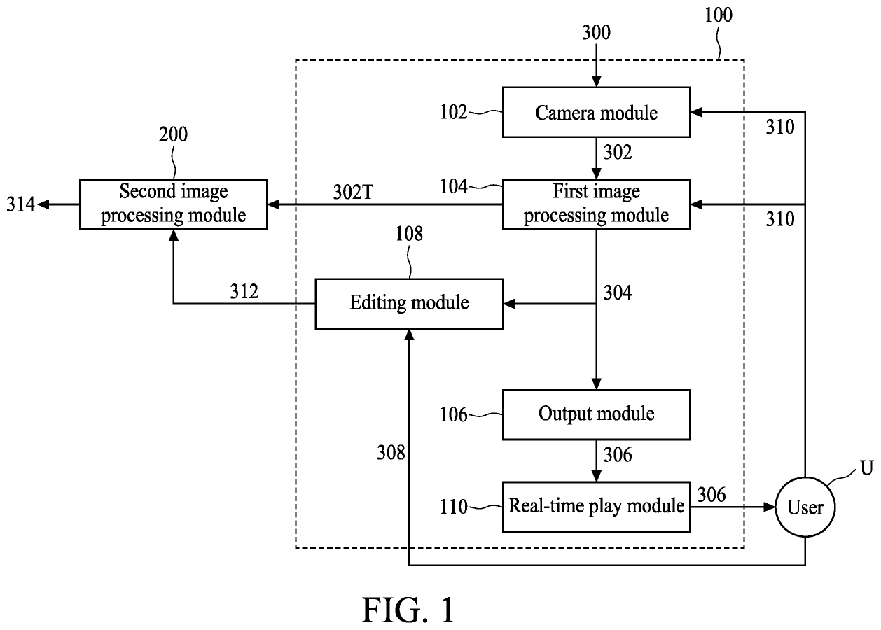

FIG. 1 is a functional block diagram of a VR real-time filming and monitoring system 100 according to one embodiment of the present application. The VR real-time filming and monitoring system 100 may include (but is not limited to) a camera module 102, a first image processing module 104, an output module 106, an editing module 108, and a real-time play module 110.

The camera module 102 is configured to shoot a video 300 and generate an original video 302. The camera module 102 may include multiple cameras (not shown in the drawings) configured to shoot the video 300 in the real world. The original video 302 can be, for example, a plurality of non-stitched videos that are filmed by multiple cameras; the original video 302 can be in the format of a RAW file or any other appropriate file format. In some embodiments, the camera module 102 may have multiple hardware functions; for example, the hardware functions can be lens correction, white balance correction, shutter control, image signal gain, frame setting, etc. For example, lens correction can be used to correct the lens; white balance correction can be applied to different situations, such as strong light, sunset, indoor, outdoor, fluorescent, or tungsten light, or it can adjust the color temperature based on a user's (U's) needs; shutter control can control the amount of light input, exposure time, etc.; image signal gain can enhance the image contrast under weak light sources; frame setting can set the frame to, for example, 24 fps, 30 fps, etc. In some embodiments, the camera module 102 can adjust the above hardware functions based on the image processing control signal 310 input by the user U.

The first image processing module 104 processes the original video 302 according to default settings (not shown in the drawings) or an image processing control signal 310 to generate a real-time video temporary data 304. In some embodiments, after the first image processing module 104 receives the unstitched original video 302, it may process, in real-time, the original video 302 according to default settings or the image processing control signal 310 inputted by the user U, and then generates the real-time video temporary data 304. In some embodiments, the first image processing module 104 includes a graphics processing unit (GPU). In other words, the first image processing module 104 can use the GPU to process the original video 302 without the need to transmit the original video 302 to a central processing unit (CPU) for processing, thereby reducing the time required for processing the image. In this case, the file format of the real-time video temporary data 304 can be H.264 and other coding formats with smaller file size. Further, the first image processing module 104 can generate an original video temporary data 302T according to the original video 302.

The output module 106 generates a first VR screening video 306 according to the real-time video temporary data 304. In some embodiments, the output module 106 converts the real-time video temporary data 304 into a file format that the real-time play module 110 can play. For example, the output module 106 can be certain VR application programmable interfaces (API), which is configured to convert the real-time video temporary data 304 into the first VR screening video 306 with a format that can be displayed using a specific VR headset.

The editing module 108 generates an edited data 312 according to the real-time video temporary data 304 and an editing command 308. In some embodiments, after the user U watches the first VR screening video 306 using the real-time play module 110, the user U may input the editing command 308 to the editing module 108 so as to edit the real-time video temporary data 304. The editing module 108 then generates the edited data 312 according to the real-time video temporary data 304 and the editing command 308. The edited data 312 may be an EDL file.

The real-time play module 110 is configured to play the first VR screening video 306, so that the user U can watch the first VR screening video 306 using the real-time play module 110. The real-time play module 110 can be, for example, a head-mounted display monitor (HMD monitor) or a VR headset.

Further, the VR real-time filming and monitoring system 100 may further couple to a second image processing module 200. For example, the second image processing module 200 can be included in a video post-production system. The second image processing module 200 receives the original video temporary data 302T and the edited data 312 and outputs a second VR screening video 314. The second VR screening video 314 is, for example, a complete VR image file. In other words, when the user confirms the completion of shooting at the scene and makes preliminary editing in real-time, the user can use the second image processing module 200 afterward to generate a further second VR screening video 314 according to the original image staging data 302T and editing data 312.

As described above, the VR real-time filming and monitoring system 100 can be used to allow the user U to film the video 300 and play the first VR screening video 306 and allow the user U to input the image processing control signal 310 and editing command 308 to the VR real-time filming and monitoring system 100 in real-time according to the first VR screening video 306.

Specifically, in the present VR real-time filming and monitoring system 100, the user U can watch the first VR screening video 306 generated by the filming of the camera module 102 through the real-time play module 110 and can adjust the settings of the camera module 102 or the first image processing module 104 again according to the first VR screening video 306 to re-shoot or re-take certain clips so that the user can improve the efficiency of the shooting process by confirming the shooting results in real-time.

Moreover, the user U can also edit the real-time video temporary data 304 that have been filmed simultaneously, and the user U may then produce the complete VR video file using the video post-production system after he or she confirms that all shooting results are satisfactory. That is, instead of recording the edited data manually as in the prior art, the user can watch the image and edit the video in real-time and generate the edited data 312 in real-time, thus avoiding the errors that may arise from manual recording.

The VR real-time filming and monitoring system 100 of the present application does not simply convert the video's file format and means of presentation but reduces the image processing time by centralizing the image processing procedures in a single processing unit (e.g., GPU). Through the technical means proposed herein, the user U can confirm the shooting results in real-time and adjust or edit the video, and there is no need to wait until the complete VR video file is completed to confirm the shooting results. In this way, the overall shooting cost can be reduced, and the shooting efficiency can be increased.

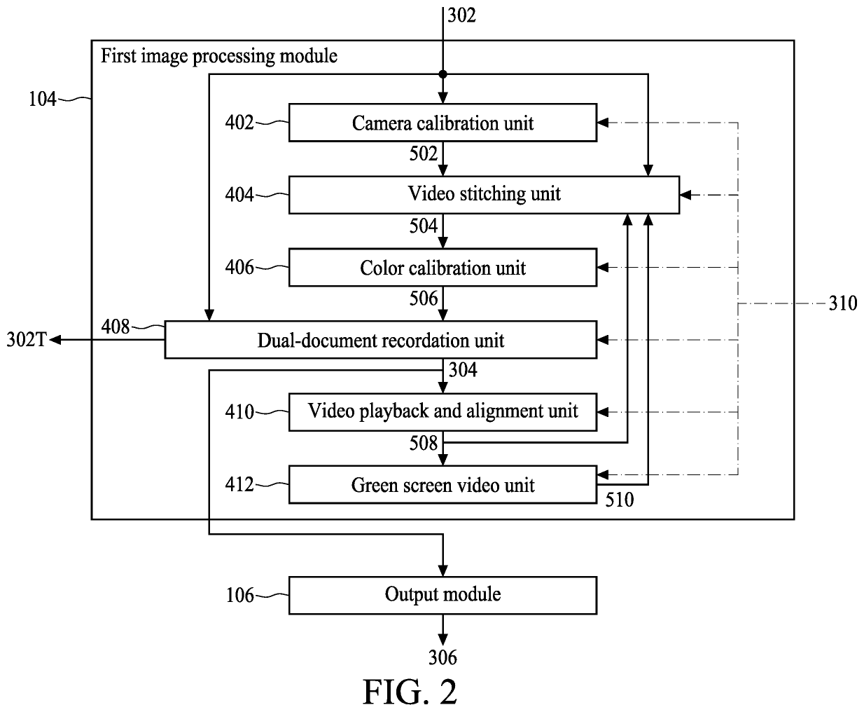

FIG. 2 is a functional block diagram of the first image processing module 104 according to one embodiment of the present application. In some embodiments, the first image processing module 104 may include (but is not limited to) a camera calibration unit 402, a video stitching unit 404, a color calibration unit 406, a dual-document recordation unit 408, a video playback and alignment unit 410, and a green screen video unit 412.

The camera calibration unit 402 outputs an alignment information 502 according to the original video 302. The alignment information 502 is the relative position information of multiple cameras in the camera module 102 (shown in FIG. 1), such as latitude and longitude (LatLong) information. Further, the camera calibration unit 402 can store the red color scale with the X-axis and the green color scale with the Y-axis. The color definition table thus-generated is then computed using an image stitching software (e.g., PTGui) to generate camera calibration parameters to redefine the cameras' positions.

The video stitching unit 404 outputs a stitched video 504 according to the original video 302 and the alignment information 502. The video stitching unit 404 can stitch the original video 302 (for example, videos taken by multiple cameras separately) into the stitched video 504 (that is, the panoramic video) in real-time. In this case, the resolution of the stitched video 504 can be adjusted as required.

The color calibration unit 406 outputs a calibrated video 506 according to the stitched video 504. After the color calibration unit 406 receives the stitched video 504, it can use, for example, the Lookup Table (LUT) of color grading in real-time to calibrate the color of the stitched video 504 using patches.

The dual-document recordation unit 408 generates the real-time video temporary data 304 according to the calibrated video 506 and generates the original video temporary data 302T according to the original video 302. The dual-document recordation unit 408 is configured to record, simultaneously, the original video temporary data 302T for use in the complete VR video file for post-production and the real-time video temporary data 304 (e.g., the H.264 format file) for real-time playing, wherein the real-time video temporary data 304 is configured to be played in real-time.

The video playback and alignment unit 410 generates an aligned video 508 according to the real-time video temporary data 304. The video playback and alignment unit 410 outputs the aligned video 508 to the video stitching unit 404, and the video stitching unit 404 can generate the stitched video 504 according to the original video 302, the alignment information 502, and the aligned video 508. In some embodiments, the aligned video 508 may be a video with higher transparency. That is, for example, the video stitching unit 404 can stitch the aligned video 508 obtained from the previous shooting with the newly shot original video 302, allowing the user to use the aligned video 508 to confirm whether the relative positions of various items in the scene of the newly shot original video 302 are correct. Besides, the video playback and alignment unit 410 can also output the aligned video 508 to the green screen video unit 412.

The green screen video unit 412 generates the green screen video 510 to the video stitching unit 404 according to the aligned video 508. In other words, when, for example, some parts of a certain scenes need to be post-produced with special effects or combined with other videos, the green screen image unit 412 can convert the aligned video 508 into a green screen image 510 that is compatible with the green screen so that the video stitching unit 404 can generate the stitched video 504 according to the original video 302, the alignment information 502 and the green screen video 510.

In view of the foregoing, the first image processing module 104 of the present application can use the dual-document recordation unit 408 to simultaneously record the original video temporary data 302T for post-production and the real-time video temporary data 304 for real-time playing and has various functions, so that the user can adjust each functional module using the image processing control signal 310 after watching the video in real-time. The first image processing module 104 of the present application does not simply convert the video's file format and means of presentation but reduces the image processing time by centralizing the image processing procedures in a single processing unit (e.g., GPU). Through the technical means proposed herein, the user U can confirm the shooting results in real-time and adjust or edit the video, and there is no need to wait until the complete VR video file is completed to confirm the shooting results. In this way, the overall shooting cost can be reduced, and the shooting efficiency can be increased.

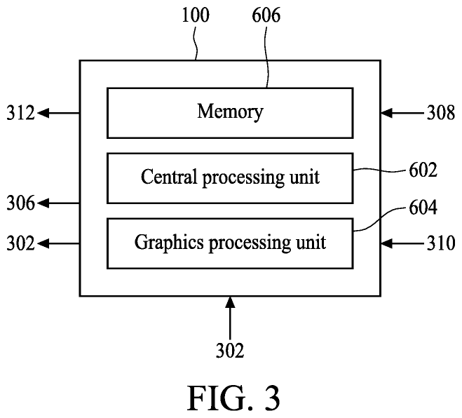

FIG. 3 is a schematic diagram illustrating the VR real-time filming and monitoring system 100 according to one embodiment of the present application. In some embodiments, the VR real-time filming and monitoring system 100 may include internal components, including a central processing unit (CPU) 602, a graphics processing unit (GPU) 604, and a memory 606. The CPU 602 can be configured to implement the general processes of the VR real-time filming and monitoring system 100, the GPU 604 is configured to execute specific graphics-intensive computation, and the memory 606 is configured to provide volatile and/or non-volatile data storage.

The CPU 602 and/or the GPU 604 may be configured to adjust the video stitching parameters or transmit the updated parameters (or instructions) to the camera module 102. The adjustments mentioned above can be made according to the user's image processing control signal 310. In some embodiments, the first image processing module 104 shown in FIG. 2 may include the GPU 604, or the first image processing module 104 may be executed through the GPU 604. In this way, there is no longer the need to transmit the original video 302 to the CPU 602 for processing, thus reducing the image process time and system resource consumption.

Other components, such as the output module 106 or the editing module 108 shown in FIG. 1, can be executed using the CPU 602 and/or the GPU 604 according to the user's setting.

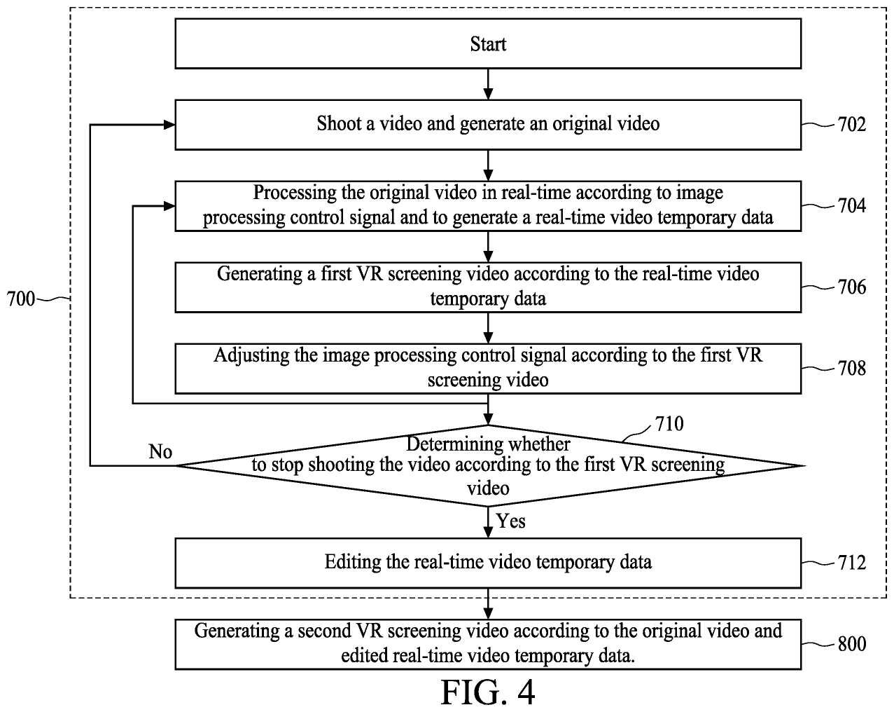

FIG. 4 is a flow chart illustrating a VR real-time filming and monitoring method 700 according to one embodiment of the present application. The VR real-time filming and monitoring method 700 includes (but is not limited to) the following steps. In Step 702, a video is shot, and an original video is generated. In Step 704, the original video is processed in real-time according to an image processing control signal so as to generate a real-time video temporary data. In Step 706, a first VR screening video is generated according to the real-time video temporary data. In Step 708, the image processing control signal is adjusted according to the first VR screening video. In Step 710, it is determined whether to stop shooting the video according to the first VR screening video. In Step 712, after stop shooting the video, the real-time video temporary data is edited. When the determination result in Step 710 is negative, the process returns to Step 702 to re-shoot the video.

Finally, after VR real-time filming and monitoring method 700 ends, in Step 800, a second VR screening video is generated according to the original video and edited real-time video temporary data generated using the VR real-time filming and monitoring method 700. Since the VR real-time filming and monitoring method has been discussed in detail above in connection with FIG. 1, FIG. 2, and FIG. 3, detailed descriptions thereof are omitted herein.

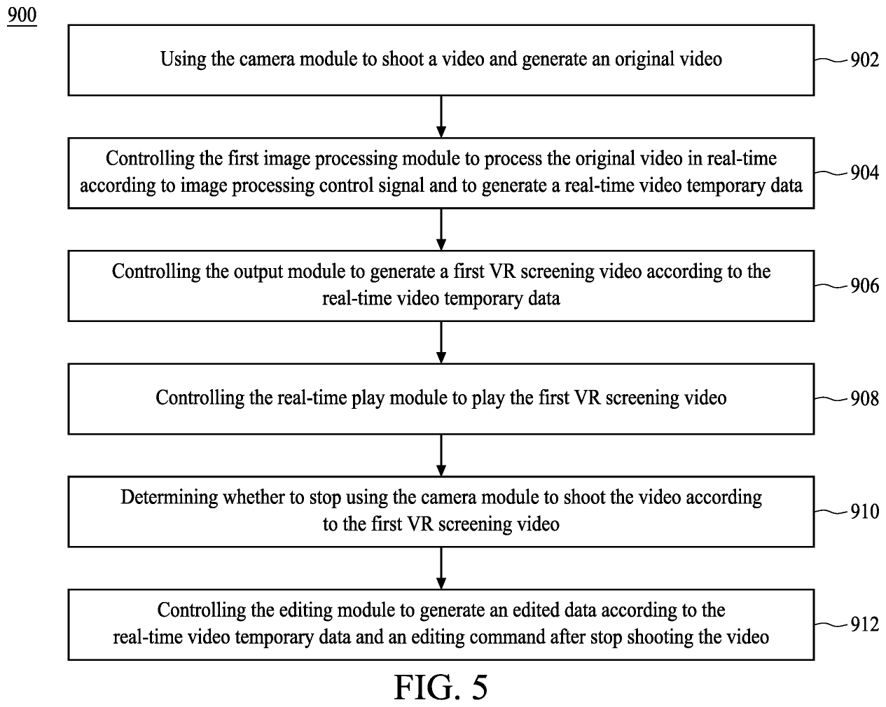

FIG. 5 is a flow chart illustrating a method 900 for controlling a VR real-time filming and monitoring system according to one embodiment of the present application. The VR real-time filming and monitoring system includes a camera module, a first image processing module, an output module, an editing module, and a real-time play module. The method 900 for controlling the VR real-time filming and monitoring system includes (but is not limited to) the following steps. In Step 902, the camera module is used to shoot a video and generate an original video. In Step 904, the first image processing module is controlled to process the original video in real-time according to the image processing control signal so as to generate a real-time video temporary data. In Step 906, the output module is controlled to generate a first VR screening video according to the real-time video temporary data. In Step 908, the real-time play module is controlled to play the first VR screening video. In Step 910, it is determined whether to stop using the camera module to shoot the video according to the first VR screening video. In Step 912, after stop shooting the video, the editing module is controlled to generate an edited data according to the real-time video temporary data and the editing command. Since the VR real-time filming and monitoring system and method for controlling the same have been discussed in detail above in connection with FIG. 1, FIG. 2, and FIG. 3, detailed descriptions thereof are omitted herein.

In view of the foregoing, in the present VR real-time filming and monitoring system and method for controlling the same, the user can use the real-time play module to watch the first VR screening video produced by shooting through the camera module. In contrast, as in the prior art, the monitoring system can only produce flat videos, and the user must imagine the VR screen on the spot based on the flat videos to direct the shooting. In other words, in the prior art, the user cannot view the video from a perspective that is very close to the final VR product during the shooting process. Furthermore, the user can now readjust the settings of the camera module or the first image processing module according to the first VR screening video and decide on the spot whether to re-shoot or re-take certain clips. In this way, the user can confirm the shooting results in real-time, thereby improving the shooting efficiency and reducing the shooting cost.

Besides, the user can also edit the filmed videos at the same time, and finally, when the user confirms that all the filming results meet the requirements, the user can create the complete VR video file through the video post-production system. In other words, the user does not need to record the editing data manually, as in the prior art, but can watch the videos and edit them in real-time, and then generate the editing data in real-time, thus avoiding the errors that may arise from manual recording and improving efficiency.

The present VR real-time filming and monitoring system and method for controlling the same do not simply convert the video's file format and means of presentation but reduce the image processing time by centralizing the image processing procedures in a single processing unit (e.g., GPU). Through the technical means proposed herein, the user can adjust or edit the video in real-time, and there is no need to wait until the complete VR video file is completed to confirm the shooting results.

The foregoing outlines features of several preferred embodiments of the present application and shall not be used to limit the scope of the present disclosure. Those skilled in the art should appreciate that there are various modifications and alterations to the present application. Any modifications, equivalent substitutions, and improvements made within the spirit and scope of the present application shall fall within the protection scope of the present disclosure.

What is claimed is:

1. A virtual reality (VR) real-time filming and monitoring system, configured to allow a user to shoot a video and play a first VR screening video, and allow the user to input, in real-time, an image processing control signal and an editing command into the VR real-time filming and monitoring system according to the first VR screening video, characterized in that the system comprises:
a camera module, configured to shoot the video and generate an original video;
a first image processing module, configured to process the original video according to the image processing control signal to generate a real-time video temporary data;
an output module, configured to generate the first VR screening video according to the real-time video temporary data;
an editing module, configured to generate an edited data according to the real-time video temporary data and the editing command; and
a real-time play module, configured to play the first VR screening video.

2. The VR real-time filming and monitoring system of claim 1, characterized in that the first image processing module includes:
a camera calibration unit, configured to output an alignment information according to the original video;
a video stitching unit, configured to output a stitched video according to the original video and the alignment information;
a color calibration unit, configured to output a calibrated video according to the stitched video; and
a dual-document recordation unit, configured to generate the real-time video temporary data according to the calibrated video and generate an original video temporary data according to the original video.

3. The VR real-time filming and monitoring system of claim 2, characterized in that the first image processing module further includes:
a video playback and alignment unit, configured to generate an aligned video according to the real-time video temporary data.

4. The VR real-time filming and monitoring system of claim 3, characterized in that the video stitching unit is configured to generate the stitched video according to the original video, the alignment information, and the aligned video.

5. The VR real-time filming and monitoring system of claim 3, characterized in that the first image processing module further includes:
a green screen video unit, configured to generate a green screen video to the video stitching unit according to the aligned video, wherein,
the video stitching unit is configured to generate the stitched video according to the original video, the alignment information, and the green screen video.

6. The VR real-time filming and monitoring system of claim 1, characterized in that the first image processing module comprises a graphics processing unit (GPU).

7. A virtual reality (VR) real-time filming and monitoring method, characterized in that the method comprises:
shooting a video and generating an original video;
processing the original video in real-time according to an image processing control signal to generate a real-time video temporary data;
generating a first VR screening video according to the real-time video temporary data; and
adjusting the image processing control signal according to the first VR screening video.

8. The VR real-time filming and monitoring method of claim 7, characterized in that the method further comprises:
determining whether to stop shooting the video according to the first VR screening video.

9. The VR real-time filming and monitoring method of claim 8, characterized in that the method further comprises:
editing the real-time video temporary data after stop shooting the video.

10. The VR real-time filming and monitoring method of claim 9, characterized in that the method further comprises:
generating a second VR screening video according to the original video and the edited real-time video temporary data.

11. A method for controlling a virtual reality (VR) real-time filming and monitoring system, wherein the VR real-time filming and monitoring system comprises a camera module, a first image processing module, an output module, an editing module, and a real-time play module, characterized in that the method comprises:
using the camera module to shoot a video and generate an original video;
controlling the first image processing module to process the original video in real-time according to image processing control signal and to generate a real-time video temporary data;
controlling the output module to generate a first VR screening video according to the real-time video temporary data; and
controlling the real-time play module to play the first VR screening video.

12. The method for controlling the VR real-time filming and monitoring system of claim 11, characterized in that the method further comprises:
determining whether to stop using the camera module to shoot the video according to the first VR screening video.

13. The method for controlling the VR real-time filming and monitoring system of claim 12, characterized in that the method further comprises:
controlling the editing module to generate an edited data according to the real-time video temporary data and an editing command after stop shooting the video.
